(19) United States
(12) Patent Application Publication
(10) Pub. No.: US 2009/0166900 A1
(43) Pub. Date: Jul. 2, 2009

(54) HIGH EFFICIENCY SELF-IMPACTING DUST REMOVER FOR GAS

(75) Inventor: Guangliang Chen, Beijing (CN)

Correspondence Address: YING CHEN;Chen Yoshimura LLP, 255 S. GRAND AVE., # 215, LOS ANGELES, CA, 90012, US

(73) Assignee: Haisibote ( Beijing ) science and technology Co., Ltd., Beijing (CN)

(21) Appl. No.: 12/118,257

(22) Filed: May 9, 2008

(30) Foreign Application Priority Data
Dec. 28, 2007 (CN) 200710304598.3

(51) Int. Cl. B01F 3/04; B01D 45/16

(52) U.S. Cl. 261/79.2; 96/306; 96/311

(57) ABSTRACT

The invention relates to a high efficiency self-impacting dust remover for gas comprising a dust tower and a matched cyclone settlement tower, wherein the dust tower includes a gas inlet pipe, a gas outlet pipe, an upper airflow guide plate and a lower airflow guide plate, the lower guide plate takes a curve shape, a front part of the lower guide plate submerged into cleaning liquid in the dust tower, wherein the cyclone settlement tower includes a tangential gas inlet connecting the gas outlet pipe of the dust tower, its inside space is divided into a lower cyclone area and an upper settlement area by a ring-shaped baffle board. Endowed with such advantages as low investment, high cleaning efficiency, relatively long service life, low water consumption and low operation cost, this dust remover is mainly used in gas cleaning and purifying in industry.

### BACKGROUND OF THE INVENTION

1. Field of the Invention

The invention relates to a high efficiency self-impacting dust remover for gas which is mainly used in gas cleaning and purifying in industry.

2. Description of the Related Art

Wet cleaning and purifying is an effective means to control air pollutions. The pollutant in gases is absorbed into cleaning liquid in wet cleaning and purifying. Such a cleaning and purifying device could be a spraying tower, a foam tower, a Venturi tube and an impacting dust remover or a self-impacting dust remover. Each of the devices has its advantages disadvantages, suitable for different usages. The issues of a self-impacting dust remover needed to be solved are: first, how to improve cleaning efficiency further; second, how to prolong their service life; and third, how to increase dehydration rate.

### SUMMARY OF THE INVENTION

To overcome above disadvantages of prior art, this invention provides a high efficiency self-impacting dust remover for gas. The dust remover has a low investment, a high cleaning efficiency, a high dehydration rate, a relatively long service life, a low water consumption and a low operation cost.

The technical solution of this invention to achieve above purposes is: a high efficiency self-impacting dust remover for gas, comprising a dust tower and a matched cyclone settlement tower, wherein the dust tower includes a gas inlet pipe, a gas outlet pipe, an upper airflow guide plate and a lower airflow guide plate, the lower guide plate takes a curve shape, a front part of the lower guide plate submerged into cleaning liquid in the dust tower, wherein the cyclone settlement tower includes a tangential gas inlet connecting the gas outlet pipe of the dust tower, its inside space is divided into a lower cyclone area and an upper settlement area by a ring-shaped baffle board.

The operation principle and the beneficial effects of this invention are that: polluted gas enters the dust tower at a high speed through the gas inlet of the dust tower and flows along the airflow guide plate direction, in particular to the lower airflow guide plate direction to impact cleaning liquid positioned on the lower guide plate and causes water fog. The gas is mixed with the water fog. Solid particles and various polluting molecules in the gas collide and react with molecules of water or additives which are used in the cleaning liquid for eliminating certain polluting molecules, entering into the cleaning liquid by a physical process or a chemical process. The cleaned gas rotates along the inner wall of the cyclone tower after entering into the cyclone tower in tangent line to form a cyclonic flow. This cleaned airflow moves upwards to form a spiral ascending state and forced to move towards the central through hole of the ring-shaped baffle board when obstructed by the ring-shaped baffle board connected with the inner wall of the tower. This kind of rotary and turning of airflow is beneficial for the collision between the gas and water of the airflow and also beneficial for throwing large water drop out. The dusts can be mixed in water and large water drops can be separated from the airflow. The separated water drops form a water membrane on the inner wall of the tower, beneficial for reducing the abrasion on the tower wall. This invention combines a dust tower and a cyclone settlement tower reasonable and achieves a multiple cleaning and an effective gas-liquid separation.

### BRIEF DESCRIPTION OF THE DRAWING

FIG. 1 is a schematic view of an embodiment of the present invention.

### DETAILED DESCRIPTION OF THE PREFERRED EMBODIMENTS

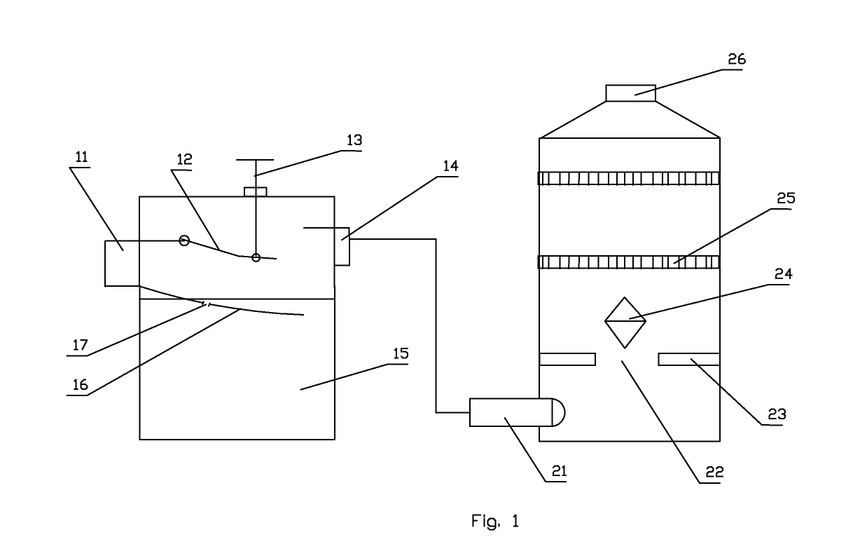

With reference to FIG. 1, this invention relates to a high efficiency self-impacting dust remover for gas, comprising a dust tower and a matched cyclone settlement tower. The dust tower includes a gas inlet pipe 11, a gas outlet pipe 14, an upper airflow guide plate 12 and a lower airflow guide plate 16. The lower airflow guide plate takes a curved line shape or a straight line shape. The front end or the whole of the lower airflow guide plate is submerged inside the cleaning liquid 15 filled inside the dust tower. The gas outlet pipe of the dust tower is connected with the gas inlet pipe 21 of the cyclone settlement tower. The cyclone settlement tower takes a tangential gas inlet structure. The inner space of the tower is divided into a lower cyclone area and an upper settlement area through a ring-shaped baffle board 23.

The lower guide plate of the dust tower includes a plurality of through holes 17 in it which are submerged inside the cleaning liquid. When the airflow impacts the cleaning liquid positioned on the lower airflow guide plate, the through holes are helpful to remain the necessary water level for self-impacting. A water membrane forms in the surface of the lower guide plate, thereby being beneficial for reducing the abrasion of the lower guide plate.

A plurality of auxiliary spraying nozzles are arranged on the airflow channel between the upper airflow guide plate and the lower airflow guide plate of the dust tower, and the water fog is sprayed into the airflow by the auxiliary spraying nozzles, thereby being beneficial for improving the cleaning and purifying efficiency.

The back end of the upper airflow guide plate is articulated with the shell of the dust tower, and the front end is provided with a screw mechanism which drives the upper airflow guide plate to move upwards and downwards. The angle of the upper guide plate can be changed by turning the screw 13 of the screw mechanism so as to expand or decrease the section area between the upper airflow guide plate and the lower airflow guide plate, thereby changing the speed of airflow.

The section of the cyclone settlement tower should be large enough, about 8 to 10 times larger than that of the guide channel which is demarcated by the upper guide plate and the lower guide plate of the dust tower. So, the speed of airflow in the cyclone settlement tower is slow enough for the water drops in the airflow to settle down through their own gravity.

A dual directional guide taper 24 (equivalent to a combination of an upward guide taper and a downward guide taper) is arranged above the central through hole 22 of the ring-shaped baffle board. The airflow entering into the cyclone settlement tower has relatively quick speed and rotates along the inner wall of the tower to form a cyclonic flow due to its tangential entering. The airflow moves upwards to form a spiral ascending state. However, the airflow spirally ascending along the inner wall of the tower is obstructed by the surrounding ring-shaped baffle board and forced to move towards the central hole of the baffle board and then move upwards after passing through the through hole. The rotary and turning type of airflow is beneficial for the collision between the inner gas and water of the airflow, so that the dusts can be mixed in water. Furthermore, the rotary and turning type of airflow is also beneficial for throwing large water drop out, thereby achieving the separation of large water drops. The water drops which are thrown out forms a water membrane on the inner wall of the tower, thereby being beneficial for reducing the abrasion on the tower wall. The dual directional guide taper is beneficial for the guide of the airflow, thereby smoothing down over-large turbulent flow and decreasing resistance. Particularly, the dual directional guide taper is always positioned in the settlement and dehydration areas, where the airflow should be stable. The design of the guide taper is beneficial for forming a stable airflow. Furthermore, the speed of the airflow is slowed during passing through the guide taper for the section area is expanded, being also beneficial for separating water drop from the airflow.

The upper part of the cyclone settlement tower includes a gas-liquid separating layer 25 which may be made up of dehydration webs, folding boards or other structures to achieve the proposal of dehydration.

The layer amount of the dehydration webs is generally 1 to 3, with a web gap of 1.5 to 2.5 mm, according to the nature and the concentration of dust and the speed of airflow. The spraying nozzles are evenly distributed on the whole section. The size of the water drops sprayed is 0.5 mm to 1.5 mm. The dusts are absorbed and the water fog particles are condensed during the collision between the water fog and the dusts so as to form large water drops which are convenient for dehydrating.

The shell of tower may include a maintaining manhole.

The gas outlet 26 of the cyclone settlement tower is positioned on top of the cyclone settlement tower.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A high efficiency self-impacting dust remover for gas, comprising:
a dust tower; and
a matched cyclone settlement tower,
wherein the dust tower includes a gas inlet pipe, a gas outlet pipe, an upper airflow guide plate and a lower airflow guide plate, the lower guide plate having a curved shape, a front part of the lower guide plate being submerged into cleaning liquid in the dust tower, and
wherein the cyclone settlement tower includes a tangential gas inlet connected to the gas outlet pipe of the dust tower, an inside space of the cyclone settlement tower being divided into a lower cyclone area and an upper settlement area by a ring-shaped baffle board.

2. The high efficiency self-impacting dust remover for gas according to claim 1, wherein the lower guide plate has a plurality of horizontal through holes, the plurality of horizontal through holes being submerged in the cleaning liquid.

3. The high efficiency self-impacting dust remover for gas according to claim 2, wherein the dust tower includes a plurality of auxiliary spraying nozzles which are arranged on an airflow channel between the upper airflow guide plate and the lower airflow guide plate.

4. The high efficiency self-impacting dust remover for gas according to claim 3, wherein a back end of the upper airflow guide plate is articulated with a shell of the dust tower.

5. The high efficiency self-impacting dust remover for gas according to claim 1, wherein the dust tower includes a screw mechanism which drives the upper airflow guide plate to move upwards and downwards.

6. The high efficiency self-impacting dust remover for gas according to claim 5 wherein a cross-sectional area of the cyclone tower is 8 to 10 times larger than that of the airflow guide channel which is defined by the upper guide plate and the lower guide plate of the dust tower.

7. The high efficiency self-impacting dust remover for gas according to claim 6, wherein the cyclone settlement tower includes a dual directional airflow guide taper which is arranged above a central through hole of the ring-shaped baffle board.

8. The high efficiency self-impacting dust remover for gas according to claim 7, wherein the cyclone settlement tower includes a gas-liquid separating layer.

9. The high efficiency self-impacting dust remover for gas according to claim 8, wherein the gas-liquid separating layer is made of dehydration webs or folding boards.

10. The high efficiency self-impacting dust remover for gas according to claim 9, wherein the spraying nozzles are evenly distributed on a cross-section of the dust tower.

11. The high efficiency self-impacting dust remover for gas according to claim 10, wherein the gas outlet of the cyclone settlement tower is positioned at a top of the cyclone settlement tower.

12. The high efficiency self-impacting dust remover for gas according to claim 4, wherein the dust tower includes a screw mechanism which drives the upper airflow guide plate to move upwards and downwards.

13. The high efficiency self-impacting dust remover for gas according to claim 12 wherein a cross-sectional area of the cyclone tower is 8 to 10 times larger than that of the airflow guide channel which is defined by the upper guide plate and the lower guide plate of the dust tower.

14. The high efficiency self-impacting dust remover for gas according to claim 13, wherein the cyclone settlement tower includes a dual directional airflow guide taper which is arranged above a central through hole of the ring-shaped baffle board.

15. The high efficiency self-impacting dust remover for gas according to claim 14, wherein the cyclone settlement tower includes a gas-liquid separating layer.

16. The high efficiency self-impacting dust remover for gas according to claim 15, wherein the gas-liquid separating layer is made of dehydration webs or folding boards.

17. The high efficiency self-impacting dust remover for gas according to claim 16, wherein the spraying nozzles are evenly distributed on a cross-section of the dust tower.

18. The high efficiency self-impacting dust remover for gas according to claim 17, wherein the gas outlet of the cyclone settlement tower is positioned at a top of the cyclone settlement tower.
